(19) United States
(12) Patent Application Publication
(10) Pub. No.: US 2026/0300195 A1
(43) Pub. Date: Oct. 1, 2026

(54) DIGITAL SIGNAL PROCESSOR (DSP) MONITORING AND DIAGNOSTIC CAPABILITIES

(71) Applicant: MaxLinear, Inc., Carlsbad, CA (US)

(72) Inventors: Sridhar Ramesh, Carlsbad, CA (US); Curtis Ling, Carlsbad, CA (US)

(73) Assignee: MaxLinear, Inc., Carlsbad, CA (US)

(21) Appl. No.: 19/578,813

(22) Filed: Mar. 25, 2026

Related U.S. Application Data
(60) Provisional application No. 63/839,984, filed on Jul. 8, 2025.
(60) Provisional application No. 63/777,644, filed on Mar. 25, 2025.

(51) Int. Cl. G06F 13/20

(52) U.S. Cl. CPC G06F 13/20

(57) ABSTRACT

Technology is disclosed for a digital signal processor. The digital signal processor may include a first path including a first path-select that may select a first linear path or a first retimed path, and a second path comprising a second path-select that may select a second linear path or a second retimed path.

### RELATED APPLICATIONS

This application claims the benefit of U.S. Provisional Application No. 63/777,644, filed Mar. 25, 2025, and U.S. Provisional Application No. 63/839,984, filed Jul. 8, 2025, the disclosures of which are each incorporated herein by reference in their entireties.

### FIELD

The examples discussed in the present disclosure are related to digital signal processors.

### BACKGROUND

Unless otherwise indicated herein, the materials described herein are not prior art to the claims in the present application and are not admitted to be prior art by inclusion in this section.

In modern network infrastructure, retimers and repeaters may be components in high-speed communication systems, used to maintain signal integrity long transmission distances. A retimer may be a device that restores degraded signals by reconditioning the waveform and recovering clock timing, effectively reducing noise and jitter. Retimers may be used in scenarios with high-loss channels or extended cable lengths.

A repeater may amplify the signal to counteract attenuation without modifying timing characteristics. While repeaters may be suitable for low-loss channels, repeaters may not address signal jitter limits applicable in more challenging transmission environments. Retimers and repeaters may aid in providing reliable, high-performance data communication, albeit with trade-offs in power consumption, latency, and cost.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some examples a digital signal processor (DSP) may include a first path including a first path-select that may select a first linear path or a first retimed path. The DSP may include a second path including a second path-select that may select a second linear path or a second retimed path.

In some examples a system may include a DSP, a first crossbar, and a second crossbar. The DSP may include a first path including a first path-select that may select a first linear path or a first retimed path, and a second path including a second path-select that may select a second linear path or a second retimed path. The first crossbar may be coupled to a first side of the DSP. The second crossbar may be coupled to a second side of the DSP.

In some examples, a method may include receiving, at a digital signal processor (DSP), a signal on a first path; selecting, at the DSP, a first linear path or a first retimed path to determine a first selected path; and sending, at the DSP, the signal to the first selected path.

### BRIEF DESCRIPTION OF THE DRAWINGS

Examples will be described and explained with additional specificity and detail through the use of the accompanying drawings in which:

FIGS. 1A-1C illustrate schematics of an exemplary switch system;

FIGS. 2A-2C illustrate schematics of an exemplary switch system;

FIG. 3 illustrates an example digital signal processor.

FIG. 4A illustrates an example digital signal processor.

FIG. 4B illustrates an example digital signal processor.

FIG. 5 illustrates an example digital signal processor.

FIG. 6 illustrates an example process flow of digital signal processing.

FIG. 7 illustrates an example communication system that may use digital signal processing.

FIG. 8 illustrates a diagrammatic representation of a machine in the example form of a computing device within which a set of instructions, for causing the machine to perform any one or more of the methods discussed herein, may be executed.

FIG. 9A illustrates an example block diagram of a data center;

FIG. 9B illustrates an example switch device;

FIG. 9C illustrates an example switch device; and

FIG. 9D illustrates an example switch device.

### DESCRIPTION

Retimers may restore degraded signals by reconditioning the waveform and recovering clock timing, effectively reducing noise and jitter. Repeaters may amplify the signal to counteract attenuation without modifying timing characteristics. A smart retimer and/or smart repeater may be used to decrease latency and decrease power usage.

A smart retimer and/or smart repeater may reduce port or lane dependent system specifications or qualifications by using autonomous, dynamic determinations of paths using retiming. A smart retimer and/or smart repeater may track component aging and variation including e.g., from field installation or repair corner cases. A smart retimer and/or smart repeater may reduce switch and physical medium dependent (PMD) stock keeping unit (SKU) management. The selection of a retimed path or linear path may be determined at run-time in which lanes may be configured independently based on deployment conditions.

Examples of the present disclosure will be explained with reference to the accompanying drawings.

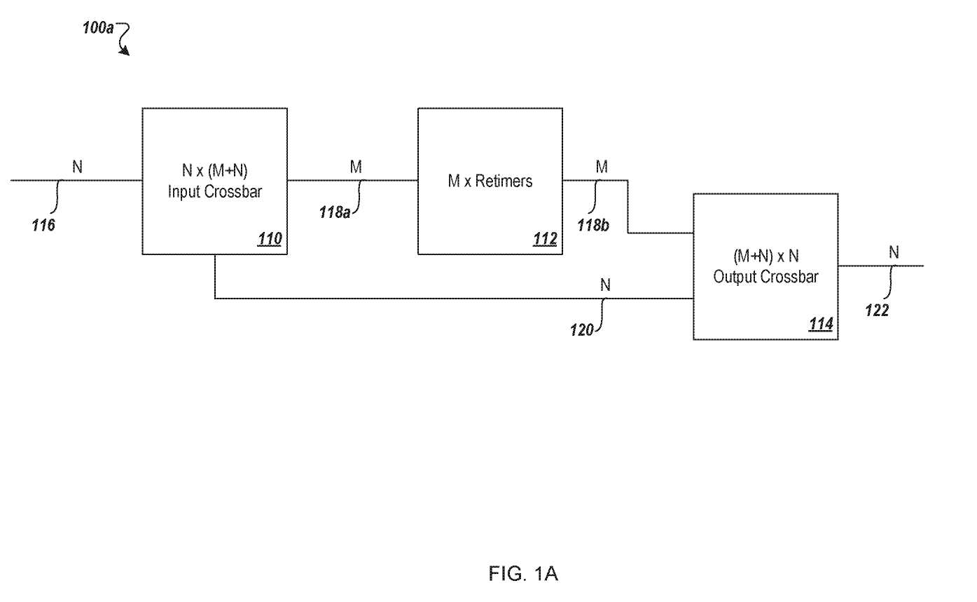

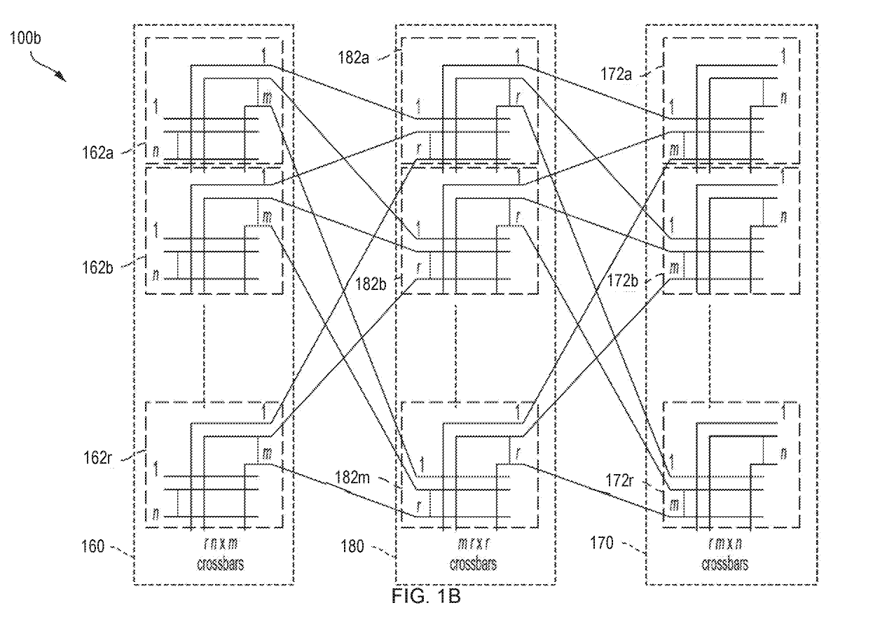

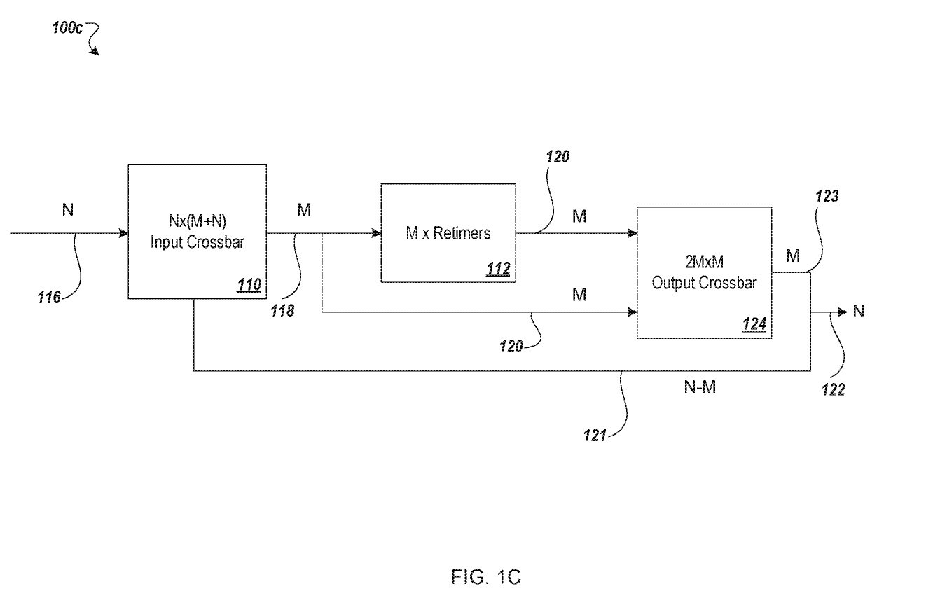

Referring now to FIGS. 1A-1C, FIGS. 1A-1C depict a schematic for implementing an adaptive retimer switch system. As shown in FIG. 1A, an adaptive retimer circuit (“circuit 100a”) includes input crossbar 110, retimers 112, and output crossbar 114. FIG. 1B depicts an exemplary crossbar 100b, which may be employed in crossbars 110, 114. FIG. 1C depicts an adaptive retimer circuit 100c.

To provide further clarity on how this structure enables efficient data handling and low-latency routing, a brief review follows. FIG. 1B illustrates exemplary underlying cross bar configurations. Crossbars may be switching matrices that may allow connections between multiple input and output ports. Crossbars may allow data from any input to be dynamically routed to any output, depending on the desired data path. In high-performance network applications, crossbars may support flexible and efficient data flow, e.g., in configurations that use dynamic routing and low latency.

FIG. 1B illustrates a schematic of interconnected crossbars with n x m, r x r, and m x n configurations, representing different crossbar sizes and configurations used within the system. The n x m crossbars manage initial data input, distributing data across multiple paths based on pre-determined routing rules or real-time decisions. The r x r crossbars in the center act as intermediate switching nodes, further enabling data from any input on one side to be routed to any output on the other side. These r x r crossbars are advantageous for handling high data traffic within complex network structures, as they allow for extensive interconnections across potential data paths. The m x n crossbars handle the data outputs, directing data from the intermediate crossbars to the final output destinations.

The configuration depicted in FIG. 1B illustrates a flexible architecture where input ports may connect to output ports via a combination of these crossbars, providing a foundation for efficient, scalable data routing in high-capacity network systems. The interconnections between these crossbars represent the data paths established between input and output lines. Each block or crossbar may handle multiple simultaneous connections, allowing for a high degree of flexibility in data routing.

The depicted configuration may allow data to traverse multiple crossbar stages, enabling complex routing patterns and supporting high bandwidth used in modern network switches. By structuring the crossbars in this manner, the system may maintain data flow continuity and avoid congestion, even under high traffic loads. Each stage of crossbars may provide additional routing options and help optimize data flow paths across the network infrastructure.

Crossbar 100b may include r nxm crossbar 160 may include crossbar 162a, 162b, 162r. Crossbar 100b may include m rxr crossbars 180 may include crossbar 182a, 182b, 182m. Crossbar 100bmay include r mxn crossbars 170 may include crossbar 172a, 172b, 172r.

Referring again to FIGS. 1A and 1C, circuit 100a and 100c illustrate a so-called "adaptive retimer" architecture, which, for example, may selectively apply retiming to those channels based on channel quality. Retimers 112 may be utilized to recondition signals on high-loss links, also referred to as "edge-case links." In contrast, low-loss channels may bypass the retimers, significantly reducing power consumption and latency for the majority of links.

Circuit 100a incorporates an input crossbar (110) that may select up to M paths using retiming and receive N paths 116, routing these paths through the retimers (112) using M paths 118a and outputting M paths 118b. The remaining N-M paths may bypass the retimers and may be routed through two analog crossbars, significantly reducing power consumption for these channels. The output crossbar (114) may consolidate data for transmission to the next stage. The output crossbar (114) may receive N paths 120 and may output N paths 122.

As shown in circuit 100c, the architecture may minimize resource utilization by employing a smaller 2M x M crossbar, which may be more compact and efficient compared to an (N+M) x N crossbar. In practical cases, where M << N, this configuration may achieve notable reductions in power dissipation and signal loss.

N-M paths 121 may be output from Nx(M+N) input crossbar 110 and may be directed to N paths 122. M paths 123 may be output from 2MxM output crossbar 124 which may be directed to N paths 122.

Some systems apply retiming universally across channels, even when not used for low-loss links, resulting in penalties to power, die area, and latency. In contrast, the adaptive retimer architecture may autonomously determine which paths use retiming based on real-time channel assessments.

The assessment may be performed using one of the retimers (112) as a "sniffer" to evaluate input channel conditions. This may be achieved by connecting the sniffing retimer to the selected input paths via the input crossbar (110) without routing the path through the output crossbar (114). Feedback from the output channels, received via in-band (IB) signaling or out-of-band (OOB) communication (e.g., inter-integrated circuit (I2C) or serial peripheral interface (SPI) protocols), may be used to confirm the routing configuration.

Sniffing operations may be conducted in a round-robin duty-cycled manner, as shown in FIG. 1A, to minimize power overhead while maintaining accurate channel assessments. The sniffing retimer may evaluate input channels periodically, ensuring optimal system performance and adaptability.

The overall architecture, as depicted in FIGS. 1A-1C, combines dynamic routing, selective retiming, and efficient crossbar configurations to address the challenges of high-performance network systems. By minimizing retiming to edge-case links and bypassing low-loss channels, the system may achieve significant power and latency savings, enhancing scalability and cost efficiency for various applications.

Modifications, additions, or omissions may be made to the components of FIG. 1 without departing from the scope of the present disclosure.

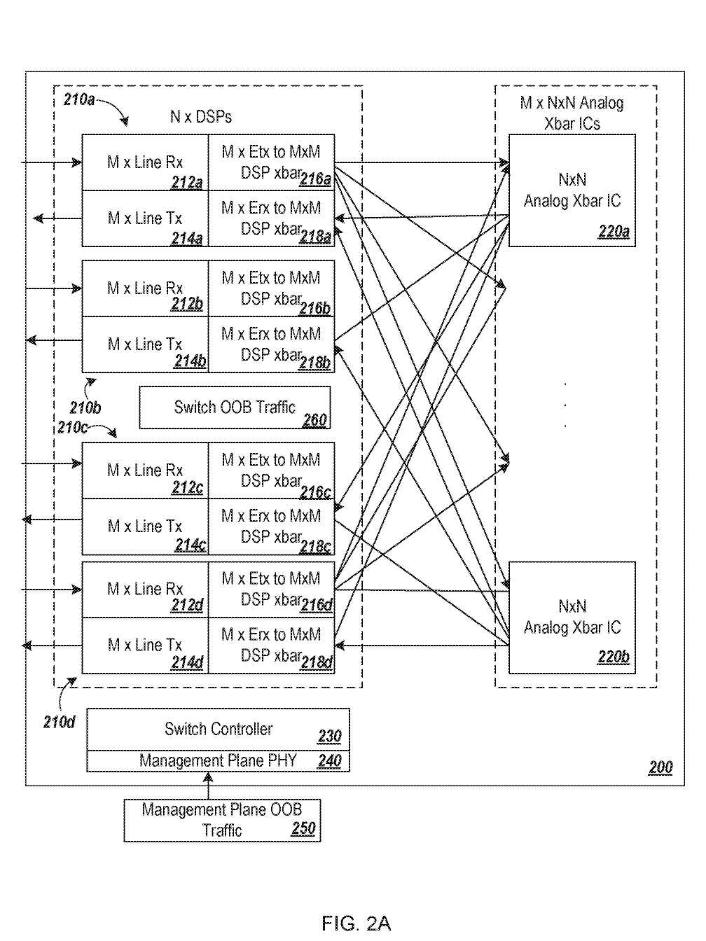

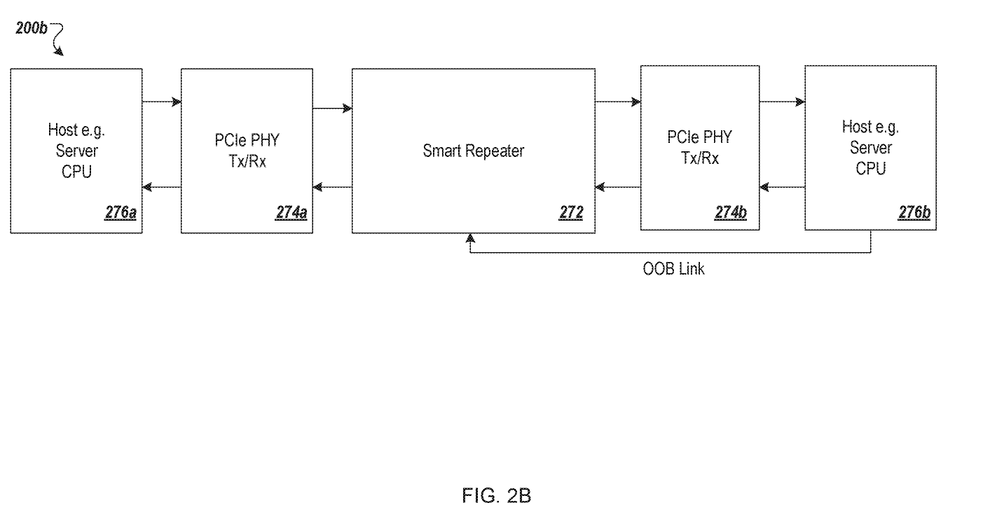

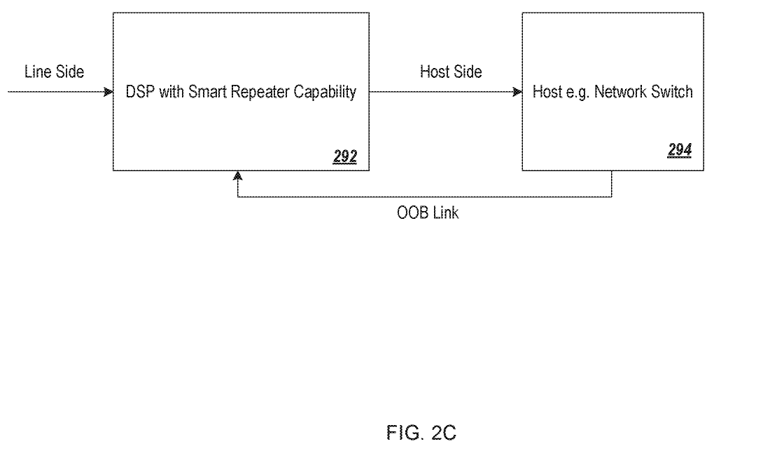

Referring now to FIG. 2A-2C, FIG. 2A illustrates an analog electrical circuit switch (AECS) system 200 (hereinafter “system 200”). System 200 may include one or more digital signal processors (DSPs) 210a, 210b, 210c, 210d. The AECS may include a switch controller 230, a management plane physical layer, and/or management plane out-of-band (OOB) traffic 250, and/or switch OOB traffic 260. System 200 may include one or more analog crossbar (“xbar”) integrated circuits (IC) (e.g., analog crossbars 220a, 220b). In this example, the switch controller may be a separate component from a DSP 210a, 210b,210c, 210d. The switch controller 230 may interface with the management plane physical layer 240. The management plane physical layer may communicate with the management plane using management plane OOB traffic 250.

DSP 210a may include an M x Line Rx212a, an M x Line Tx214a, an M x ETx to MxM DSP xbar 216a, and an M x ERx to MxM DSP xbar 218a. A DSP 210bmay include an M x Line Rx 212b, an M x Line Tx 214b, an M x ETx to MxM DSP xbar 216b, and an M x ERx to MxM DSP xbar 218b. A DSP 210cmay include an M x Line Rx 212c, an M x Line Tx 214c, an M x ETx to MxM DSP xbar 216c, and an M x ERx to MxM DSP xbar 218c. A DSP 210dmay include an M x Line Rx 212d, an M x Line Tx 214d, an M x ETx to MxM DSP xbar 216d, and an M x ERx to MxM DSP xbar 218d. A DSP xbar may be a digital crossbar integrated in the DSP.

A client may be a system communicating line-side in-band traffic to the AECS 200. For example, a server may be a system communicating line-side in-band traffic to the AECS 200. Line-side in-band (IB) bandwidth may be line traffic communicated to or from a client. IB switch traffic may be IB traffic directed into or out of or within the AECS 200. The switch controller (SC) 230 may manage and control AECS 200 devices. In one example, the switch controller 230 may be a microcontroller unit (MCU). Alternatively or in addition, the switch controller 230 may be a DSP.

Switch OOB traffic may be traffic among the SC 230, DSP 210a, 210b, 210c, 210d, analog crossbars 220a, 220b carried on a different network and physical layer than IB; may be carried on analog crossbars 220a, 220bwith redundancy. An “Xbar IC” may be an analog Xbar IC which may be a chip implementing an analog crossbar with input and output lanes.

Management plane OOB traffic may be traffic from outside system 200 via management plane physical layer (PHY) to configure and manage the AECS. System 200 may utilize in-band signaling to facilitate control signaling within a payload. In-band control may be performed by allowing clients to communicate with the device via in-band bandwidth (e.g., an in-band payload) by addressing DSPs 210a, 210b, 210c, 210d and/or the switch controller 230. Packet headers and/or frame headers may be inspected by DSPs 210a, 210b, 210c, 210dfor routing within the device, or for being sent to the switch controller 230.

The switch controller 230 may facilitate resource allocation. The switch controller 230 may communicate using OOB signaling to facilitate control signaling within the device. Using OOB signaling for control plane traffic may provide for management tasks that may not impact data flows. OOB wiring may include a dedicated layer from DSPs 210a,210b, 210c, 210d to analog crossbars 220a, 220band/or a microcontroller. The OOB wiring may be compatible with DSPs 210a, 210b, 210c, 210dby using e.g., I2C and/or SPI, another OOB input/output mode, or the like. The switch controller 230 may communicate via OOB network interface card (NIC) (e.g., using 10 Gbps Ethernet) to the datacenter.

The control plane may manage the device using a control plane physical layer. The client may signal the device by a separate network connection carrying control plane traffic. Out-of-band signaling within the device may use a separate physical layer and connectivity for communication among DSPs 210a, 210b, 210c, 210d, analog crossbars, 220a, 220b, and/or the switch controller 230. The communication may include one or more of SPI, I2c, OOB input/output, or the like. Out-of-band signaling within the device may be used for control, management, and/or synchronization of the device.

The analog crossbars 220a, 220b (e.g., as an analog crossbar integrated circuit) may have an OOB transceiver. The OOB transceiver may communicate using one or more of SPI, I2C, 10 Gbps serializer/deserializer (SERDES), or the like. The analog crossbars 220a, 220bmay be addressable using a protocol. The OOB transceiver may tap one or more of the analog crossbars 220a, 220binputs and/or outputs. One or more of R redundant inputs may be used.

The device may include a redundant crossbar which may be used to communicate using one or more of IB signaling and/or OOB signaling when failover occurs. The redundant crossbars and/or communication paths for OOB traffic and/or IB traffic may provide for failover and/or fault tolerance in control operations.

Redundancy may allow communication to DSPs 210a, 210b, 210c, 210dwithout blocking IB signaling. The switch controller 230 may broadcast to DSPs 210a, 210b, 210c, 210dand/or analog crossbars 220a, 220b. The switch controller 230 may use OOB signaling to communicate with individual DSPs 210a, 210b, 210c, 210dand/or analog crossbars 220a, 220b. Time division multiplexing (TDM) and/or broadcast may be used to address a subset of DSPs 210a, 210b, 210c, 210d and/or analog crossbars 220a, 220b.

An OOB transceiver may be integrated in analog crossbars 220a, 220band may be individually addressable and/or use TDM. One or more auxiliary IB transceivers may be included in DSPs 210a, 210b, 210c, 210d. The auxiliary IB channel may use the same physical layer as other IB channels. The auxiliary IB may use redundant analog crossbars 220a,220b to communicate with other devices. The auxiliary IB channel may be used to deliver and/or combine IB traffic e.g., from one or more of DSPs 210a, 210b, 210c,210dIB lanes. The auxiliary IB channel may communicate with nearest neighbors e.g., using a separate wire to connect nearest neighbor auxiliary IB lanes.

One or more redundant R lanes may be used for OOB signaling. For example, an OOB transceiver within DSPs 210a, 210b, 210c, 210dand/or within the switch controller 230 may be used for OOB signaling. The switch controller 230 may use one or more of R lanes to connect to DSPs 210a,210b, 210c, 210d. The OOB transceiver may use a lower rate than an IB transceiver (e.g., using I2C, SPI, 10 Gbps SERDES, or the like).

Referring to FIG. 2B, the AECS system 200 may employ adaptive retimers for selective retiming of traffic between peripheral component interconnect express (PCIe) PHYs (e.g., PCIe PHY Tx/Rx 274aand PCIe PHY Tx/Rx 274b) and server CPUs (e.g., Host 276aand Host 276b). An adaptive retimer circuit 200bmay communicate with PCIe PHYs and CPUs via OOB links to enable adaptive configurations based on channel conditions. The OOB link may allow for the exchange of control and configuration information without interfering with IB traffic, ensuring efficient system management. The smart repeater 272 may interface communicate with PCIe PHY Tx/Rx 274aand PCIe PHY Tx/Rx 274b.

Referring to FIG. 2C, a DSP with adaptive retimer capability (e.g., DSP with smart repeater capability 292) is shown, where the line-side IB traffic may be routed through the DSP, and the host-side traffic may be directed toward a network switch. In this configuration, OOB signaling may facilitate real-time control and monitoring of retimer and repeater functionalities, ensuring that the channels using retiming are processed, thereby reducing power consumption and latency for low-loss channels. The DSP with smart repeater capability 292 may communicate with a host 294 e.g., network switch.

The AECS system 200 may support high-performance applications such as PCIe repeaters, DSPs for data center interconnects, pluggable optics, Active Optical Cables (AOCs), and Active Electrical Cables (AECs). These systems may utilize an adaptive retimer design with M=N, allowing all N lanes to be retimed. For example, an 8-lane DSP may incorporate an 8x8 crossbar for retiming operations, with penalties restricted to high-loss edge-case channels.

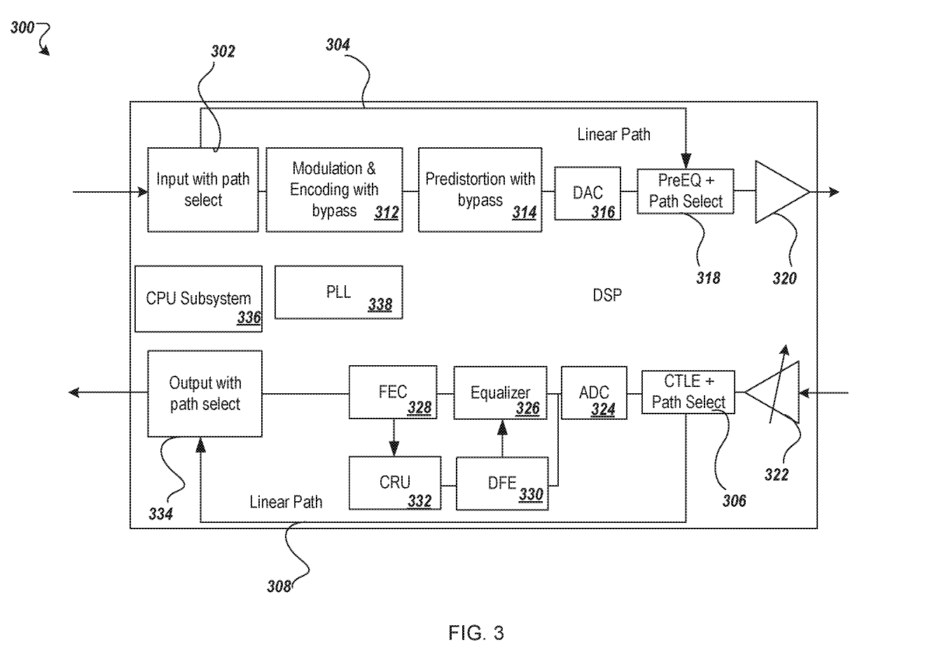

As illustrated in FIG. 3, a digital signal processor 300 may include a first path. The first path may include a first path select 302 that may select a first linear path 304 or a first retimed path. The first retimed path may include a path from first path select 302 to modulation and encoding with bypass 312 to pre-distortion with bypass 314 to digital-to-analog converter (DAC) 316, to pre-equalizer with path select 318 to amplifier 320. The digital signal processor 300 may include a second path. The second path may include a second path select 306 that may select a second linear path 308 or a second retimed path. The second retimed path may include a path from the second path select 306 to the analog-to-digital converter (ADC) 324 to the equalizer 326 to the forward error correction (FEC) 328 to the output with path select 334. The second retimed path may include a clock recovery unit (CRU) 332 and/or a decision feedback equalizer (DFE) 330. The digital signal processor 300 may include a CPU subsystem 336 and/or a phase locked loop (PLL) 338.

The path-selects 302, 306 may be based on one or more of an input channel estimate or an output channel estimate. The first path-select 302 may select the first linear path 304 or the first retimed path based on one or more of an input channel estimate or an output channel estimate. The second path select 306 may select the second linear path 308 or the second retimed path based on one or more of the input channel estimate or the output channel estimate.

The path selects may select the linear paths or the retimed paths during runtime. The first path select 302 may select the first linear path 304 or the first retimed path during a runtime. The second path-select 306 may select the second linear path 308 or the second retimed path during the runtime. These selections by the path select may be applicable to various devices such as optical and electrical pluggables, backplane, and PCIe. The linear paths 304, 308 may be un-retimed paths.

The retimed paths may include various components. For example, the first retimed path may include one or more of a modulation and encoding with bypass 312, a pre-distortion with bypass 314, a DAC 316, a pre-equalizer with path select 318, the like, or a combination thereof. For example, the second retimed path may include one or more of a continuous time linear equalizer (CTLE) with path select 306, an ADC 324, an equalizer 326, a forward error correction 328, a CRU 332, a DFE 330, the like, or a combination thereof. The DSP 300 may be coupled to a first crossbar (e.g., at a first side of the DSP 300), and to a second crossbar (e.g., at a second side of the DSP 300).

A management layer may override the DSP’s 300 selection by the first path-select 302 and/or the second path-select 306. The management layer may override one or more of the first path-select 302 or the second path-select 306 using data center management software and/or configuration.

The DSP 300 may access un-retimed margin based on one or more channel characteristics. That is, the DSP 300 may characterize channels to access available unretimed margin.

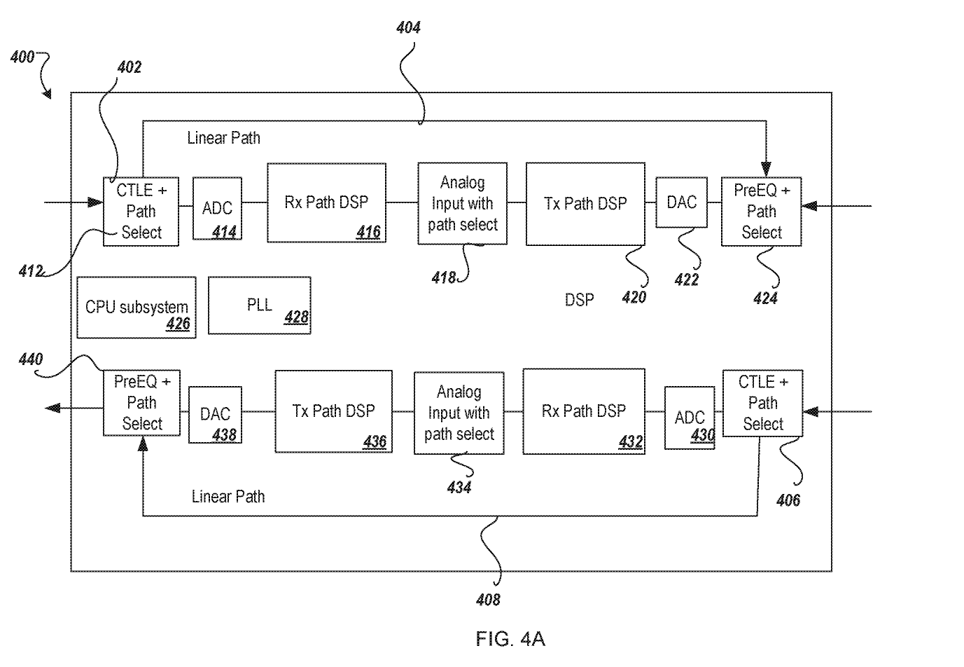

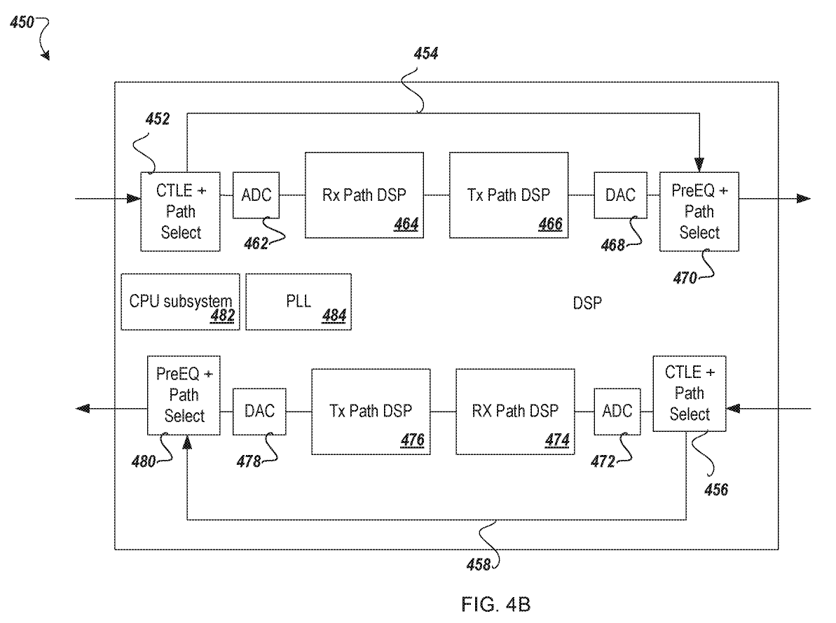

As illustrated in FIG. 4A, a DSP 400 may include a first path that may include a first path-select 402. The first path-select 402 may select a first linear path 404 or a first retimed path. The DSP 400 may include a second path that may include a second path-select 406. The second path-select 406 may select a second linear path 408 or a second retimed path.

The first path-select 402 and/or the second path-select 406 may select the linear path or the retimed path based on one or more of an input channel estimate or an output channel estimate. The first path-select 402 may select the first linear path 404 or the first retimed path based on an input channel estimate or an output channel estimate. The second path-select 406 may select the second linear path 408 or the second retimed path based on an input channel estimate or an output channel estimate.

The first path-select 402 and/or the second path-select 406 may select the linear path or the retimed path during a runtime. The runtime selection of which paths are retimed or low-power unretimed may be applicable to optical and/or electrical pluggables, backplane, and/or PCIe. The first linear path and/or the second linear path may be an unretimed path.

The retimed paths may include various components. The first retimed path and/or the second retimed path may include one or more of a CTLE (e.g., with second path select 406 or with first path select 412), an ADC 414, 430, a receive path DSP 416, 432, an analog input with path select 418, 434, a transmit path DSP 420, 436, a DAC 422, 438, a pre-equalizer 424, 440, or the like.

The DSP 400 may include a first crossbar coupled to a first side of the DSP 400 and a second crossbar coupled to a second side of the DSP 400. The crossbar may be a 2x1 crossbar. The DSP 400 may include a management layer that may override one or more of the first path-select or the second path-select. The DSP 400 may assess un-retimed margin based on one or more channel characteristics.

As illustrated in FIG. 4B, a DSP 450 may include a first path that may include a first path-select 452. The first path-select 452 may select a first linear path 454 or a first retimed path. The DSP 450 may include a second path that may include a second path-select 456. The second path-select 456 may select a second linear path 458 or a second retimed path.

One or more of the first retimed path or the second retimed path may include various components including one or more of a CTLE 452, 456, an ADC 462, 472, a receive path DSP 464, 474, a transmit path DSP 466, 476, a DAC 468, 478, a pre-equalizer 470, 480, or the like. The DSP 450 may include a CPU subsystem 482 and/or a phase locked loop (PLL) 484. The DSP 450 may include a first crossbar coupled to a first side of the DSP 450 and a second crossbar coupled to a second side of the DSP 450.

The DSP 450 may characterize one or more channels to assess the available unretimed margin. There may be runtime selection of which paths are retimed or low-power unretimed, which may be applicable to optical and/or electrical pluggables, backplane, and/or PCIe.

The DSP 450 may eliminate port and/or lane dependent system specification by using autonomous, dynamic determination of paths using retiming. In addition or alternatively, the DSP 450 may track component aging and variation (including e.g., field installation and repair corner cases). In addition or alternatively, the DSP 450 may eliminate switch and/or PMD SKU management complexities because a retimed path and/or linear path may be determined at run-time in which lanes may be configured independently based on deployment conditions. In addition or alternatively, datacenter management and/or monitoring may override the DSP 450 decisions for the lanes.

The monitoring and diagnostic capabilities of the DSP 450 may be activated on a duty-cycle basis to monitor the quality of the received signal. For example, the quality of the received signal may be monitored for a few seconds per minute. The quality of the received signal may be monitored using eye diagrams, histograms, bit error rate (BER), or the like. In some examples, lanes may be powered on individually to minimize the power impact. As a result, the DSP 450 may track changes in the channel due to aging, voltage drift, or the like.

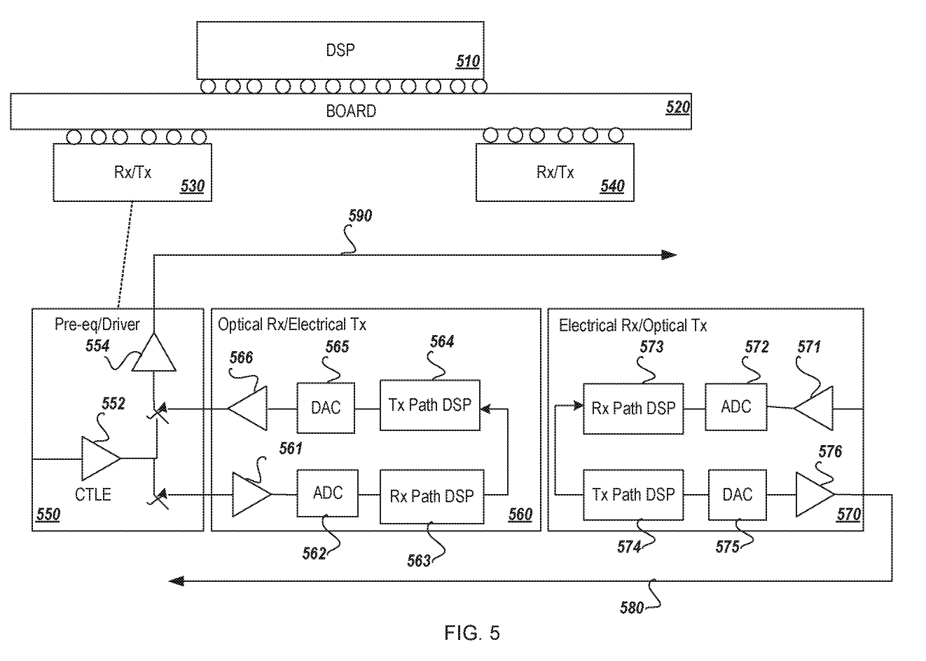

FIG. 5 illustrates an example block diagram 500 including a DSP 510 that may be coupled to a board 520 that may be coupled to one or more Rx/Tx 530, 540. The DSP 510 and the one or more Rx/Tx 530, 540 may be integrated onto the board 520 to enhance the signal integrity.

A smart retimer integrated circuit 550 (e.g., a SiGe smart retime integrated circuit that may have 8 lanes) may include a CTLE 552 and a pre-equalization driver 554. The smart retimer integrated circuit 550 may include one or more switches. The pre-equalization driver 554 may be coupled to a direct path 590.

The smart retimer integrated circuit 550 may be coupled to an optical Rx/electrical Tx 560. The optical Rx/electrical Tx may include an amplifier 561, an ADC 562, an Rx Path DSP 563, a Tx Path DSP 564, a DAC 565, and/or an amplifier 566. The amplifier 561 may be coupled to one or more switches from the smart retimer integrated circuit 550. The amplifier 566 may be coupled to one or more switches from the smart retimer integrated circuit 550.

The electrical Rx/optical Tx 570 may include one or more of an amplifier 571, an ADC 572, an Rx Path DSP 573, a Tx Path DSP 574, a DAC 575, and/or an amplifier 576. The amplifier 576 may be coupled to a direct path 580. The optical Rx/electrical Tx 560 and the electrical Rx/optical Tx 570 may be integrated on the same integrated circuit.

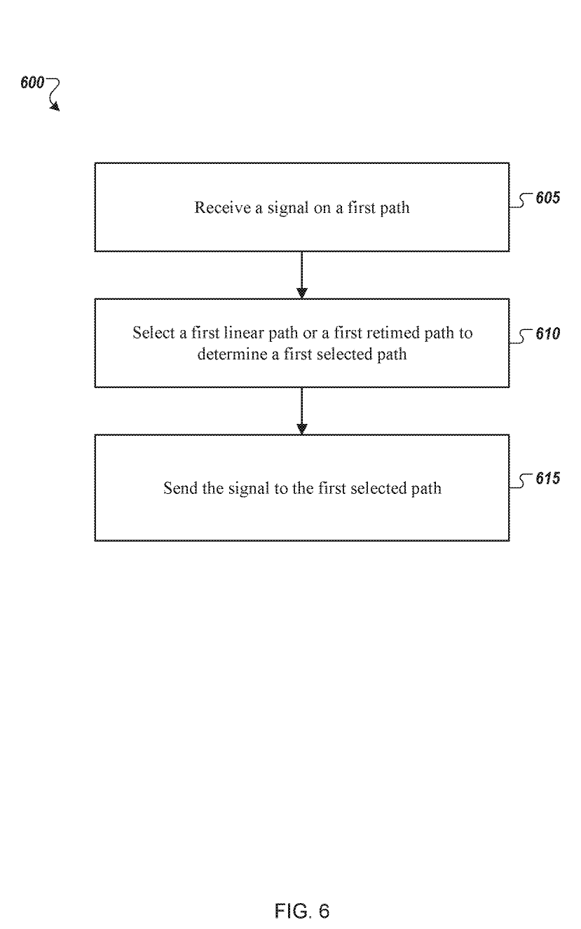

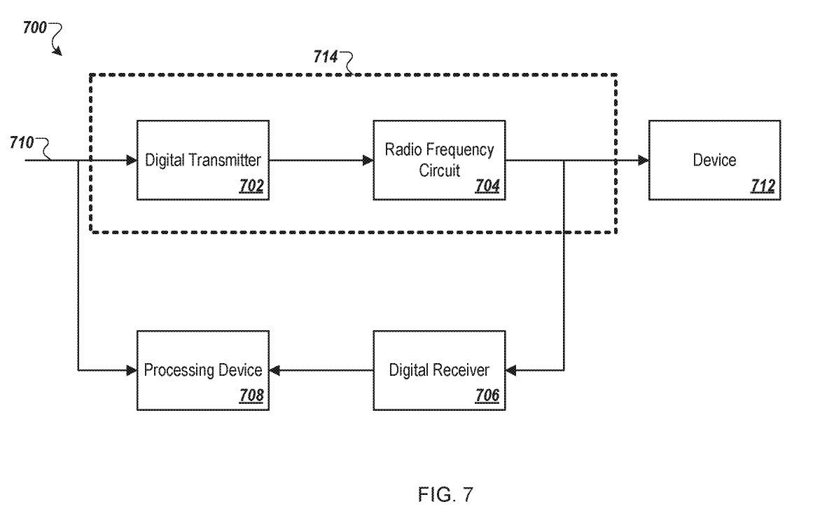

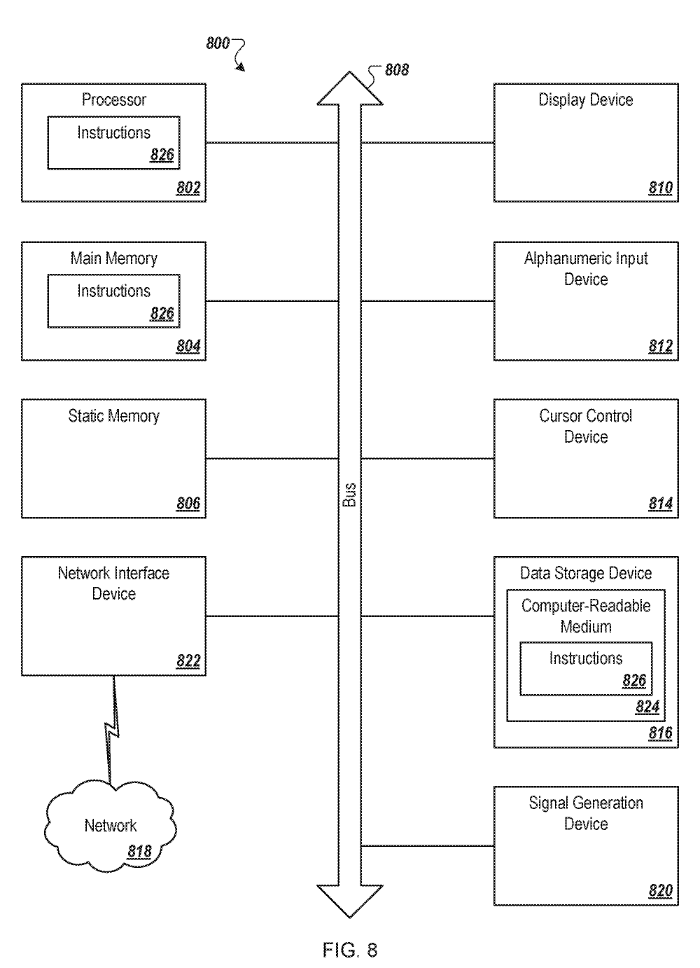

FIG. 6 illustrates a process flow of an example method 600 of digital signal processing, in accordance with at least one example described in the present disclosure. The method 600 may be arranged in accordance with at least one example described in the present disclosure. The method 600 may be performed by processing logic that may include hardware (circuitry, dedicated logic, etc.), software (such as is run on a computer system or a dedicated machine), or a combination of both, which processing logic may be included in the processing device 802 of FIG. 8, the communication system 700 of FIG. 7, or another device, combination of devices, or systems.

The method 600 may begin at block 605 where the processing logic may receive, at a digital signal processor (DSP), a signal on a first path. At block 610, the processing logic may select, at the DSP, a first linear path or a first retimed path to determine a first selected path. At block 615, the processing logic may send, at the DSP, the signal to the first selected path.

The processing logic may receive, at a digital signal processor (DSP), a signal on a second path. The processing logic may select, at the DSP, a second linear path or a second retimed path to determine a second selected path. The processing logic may send, at the DSP, the signal to the second selected path.

The processing logic may select the first selected path based on one or more of an input channel estimate or an output channel estimate. The processing logic may select the first selected path during a runtime. The processing logic may receive the signal from a first crossbar coupled to a first side of the DSP. The processing logic may override, at a management layer, the first selected path. The processing logic may assess un-retimed margin based on one or more channel characteristics.

Modifications, additions, or omissions may be made to the method 600 without departing from the scope of the present disclosure. For example, in some examples, the method 600 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or reduced, depending on the desired implementation.

FIG. 7 illustrates a block diagram of an example communication system 700 for digital signal processing, in accordance with at least one example described in the present disclosure. The communication system 700 may include a digital transmitter 702, a radio frequency circuit 704, a device 712, a digital receiver 706, and a processing device 708. The digital transmitter 702 and the processing device 708 may receive a baseband signal via connection 710. A transceiver 714 may comprise the digital transmitter 702 and the radio frequency circuit 704.

In some examples, the communication system 700 may include a system of devices that may communicate with one another via a wired or wireline connection. For example, a wired connection in the communication system 700 may include one or more Ethernet cables, one or more fiber-optic cables, and/or other similar wired communication mediums. Alternatively, or additionally, the communication system 700 may include a system of devices that may communicate via one or more wireless connections. For example, the communication system 700 may include one or more devices that may transmit and/or receive radio waves, microwaves, ultrasonic waves, optical waves, electromagnetic induction, and/or similar wireless communications. Alternatively, or additionally, the communication system 700 may include combinations of wireless and/or wired connections. In these and other examples, the communication system 700 may include one or more devices that may obtain a baseband signal, perform one or more operations to the baseband signal to generate a modified baseband signal, and transmit the modified baseband signal, such as to one or more loads.

In some examples, the communication system 700 may include one or more communication channels that may communicatively couple systems and/or devices included in the communication system 700. For example, the transceiver 714 may be communicatively coupled to the device 712.

In some examples, the transceiver 714 may obtain a baseband signal. For example, as described herein, the transceiver 714 may generate a baseband signal and/or receive a baseband signal from another device. In some examples, the transceiver 714 may transmit the baseband signal. For example, upon obtaining the baseband signal, the transceiver 714 may transmit the baseband signal to a separate device, such as the device 712. Alternatively, or additionally, the transceiver 714 may modify, condition, and/or transform the baseband signal in advance of transmitting the baseband signal. For example, the transceiver 714 may include a quadrature up-converter and/or a DAC that may modify the baseband signal. Alternatively, or additionally, the transceiver 714 may include a direct radio frequency (RF) sampling converter that may modify the baseband signal.

In some examples, the digital transmitter 702 may obtain a baseband signal via connection 710. In some examples, the digital transmitter 702 may up-convert the baseband signal. For example, the digital transmitter 702 may include a quadrature up-converter to apply to the baseband signal. In some examples, the digital transmitter 702 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 702.

In some examples, the transceiver 714 may include one or more subcomponents that may be used in preparing the baseband signal and/or transmitting the baseband signal. For example, the transceiver 714 may include an RF front end (e.g., in a wireless environment) which may include a power amplifier (PA), a digital transmitter (e.g., 702), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, or the like. In some examples, a radio (e.g., a radio frequency circuit 704) of the transceiver 714 may be synchronized with the resource controller via the S-plane device, which may contribute to high-accuracy timing with respect to a reference clock.

In some examples, the transceiver 714 may obtain the baseband signal for transmission. For example, the transceiver 714 may receive the baseband signal from a separate device, such as a signal generator. For example, the baseband signal may come from a transducer that may convert a variable into an electrical signal, such as an audio signal output of a microphone picking up a speaker's voice. Alternatively, or additionally, the transceiver 714 may generate a baseband signal for transmission. In these and other examples, the transceiver 714 may transmit the baseband signal to another device, such as the device 712.

In some examples, the device 712 may receive a transmission from the transceiver 714. In some examples, the transceiver 714 may transmit a baseband signal to the device 712.

In some examples, the radio frequency circuit 704 may transmit the digital signal received from the digital transmitter 702. In some examples, the radio frequency circuit 704 may transmit the digital signal to the device 712 and/or the digital receiver 706. In some examples, the digital receiver 706 may receive a digital signal from the RF circuit and/or send a digital signal to the processing device 708.

In some examples, the processing device 708 may be a standalone device or system, as illustrated. Alternatively, or additionally, the processing device 708 may be a component of another device and/or system. For example, in some examples, the processing device 708 may be included in the transceiver 714. In instances in which the processing device 708 is a standalone device or system, the processing device 708 may communicate with additional devices and/or systems remote from the processing device 708, such as the transceiver 714 and/or the device 712. For example, the processing device 708 may send and/or receive transmissions from the transceiver 714 and/or the device 712. In some examples, the processing device 708 may be combined with other elements of the communication system 700.

FIG. 8 illustrates a diagrammatic representation of a machine in the example form of a computing device 800 within which a set of instructions, for causing the machine to perform any one or more of the methods discussed herein, may be executed. The computing device 800 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 800 includes a processing device (e.g., a processor) 802, a main memory 804 (e.g., read-only memory (ROM), flash memory, dynamic random access memory (DRAM) such as synchronous DRAM (SDRAM)), a static memory 806 (e.g., flash memory, static random access memory (SRAM)) and a data storage device 816, which communicate with each other via a bus 808.

Processing device 802 represents one or more general-purpose processing devices such as a microprocessor, central processing unit, or the like. More particularly, the processing device 802 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also include one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein.

The computing device 800 may further include a network interface device 822 which may communicate with a network 818. The computing device 800 also may include a display device 810 (e.g., a liquid crystal display (LCD) or a cathode ray tube (CRT)), an alphanumeric input device 812 (e.g., a keyboard), a cursor control device 814 (e.g., a mouse) and a signal generation device 820 (e.g., a speaker). In at least one example, the display device 810, the alphanumeric input device 812, and the cursor control device 814 may be combined into a single component or device (e.g., an LCD touch screen).

The data storage device 816 may include a computer-readable storage medium 824 on which is stored one or more sets of instructions 826 embodying any one or more of the methods or functions described herein. The instructions 826 may also reside, completely or at least partially, within the main memory 804 and/or within the processing device 802 during execution thereof by the computing device 800, the main memory 804 and the processing device 802 also constituting computer-readable media. The instructions may further be transmitted or received over a network 818 via the network interface device 822.

While the computer-readable storage medium 824 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media, and magnetic media.

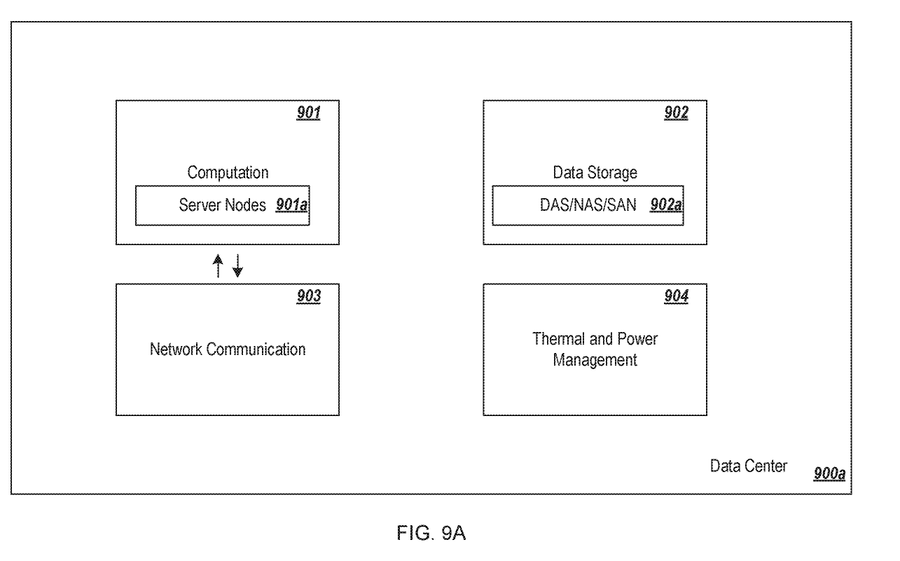

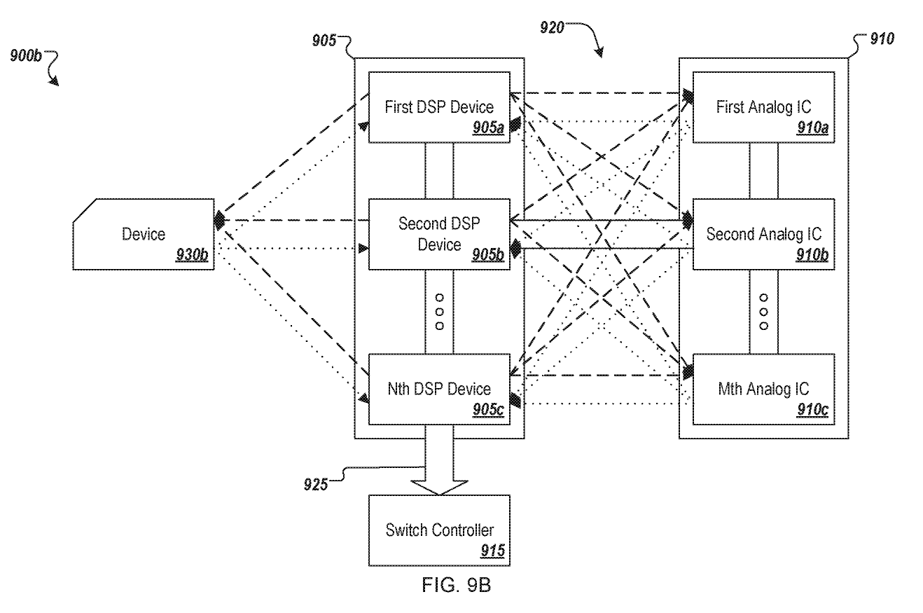

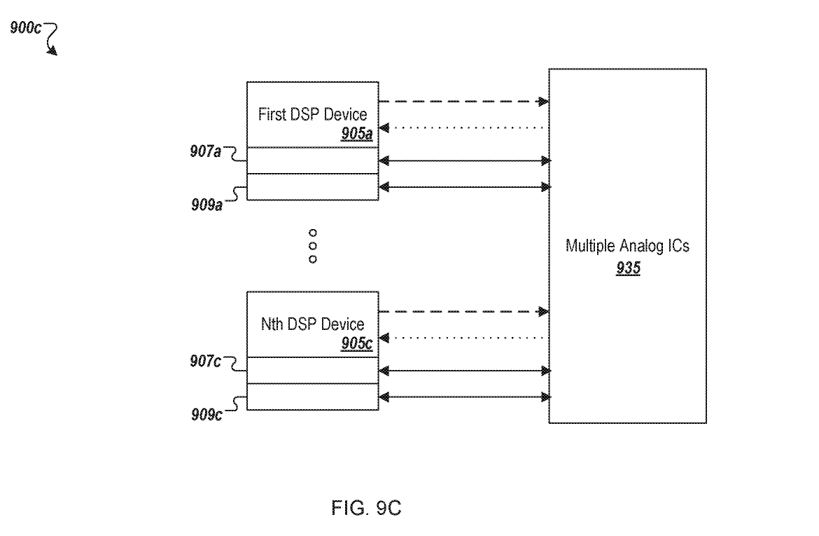

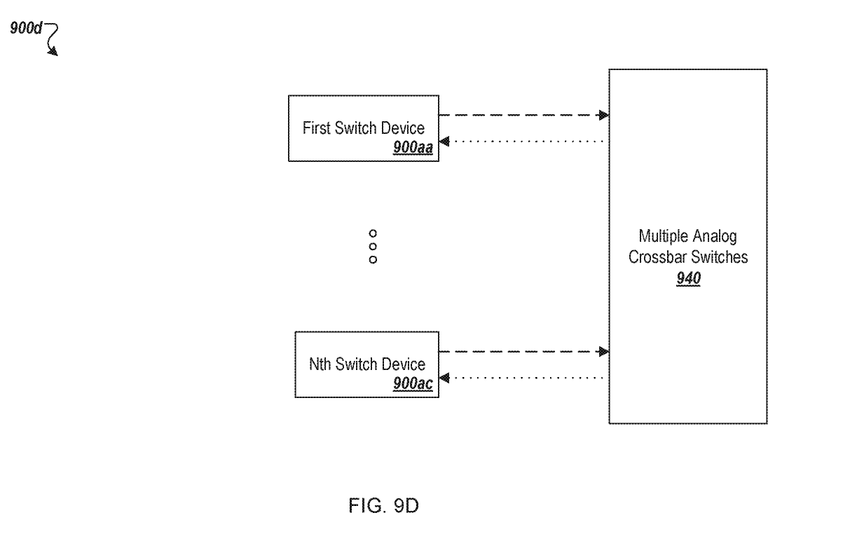

As illustrated in FIG. 9A, a block diagram of a data center 900a may include multiple subsystems configured to perform various operational functions, including computation 901, data storage 902, network communication 903, and thermal and power management 904. The computation 901 subsystem may include one or more server nodes 901a that may execute software applications and process data workloads. The data storage 902 subsystem may provide persistent data retention through devices such as hard disk drives, solid-state drives, or distributed storage arrays, which may be organized in configurations such as Direct Attached Storage (DAS), Network Attached Storage (NAS), or Storage Area Networks (SAN) 902a. The networking communication 903 subsystem may facilitate bidirectional data transfer between servers and external networks through high-speed switching and routing components. The thermal and power management 904 subsystem may maintain operational integrity by regulating temperature and supplying uninterrupted electrical power, e.g., through redundant power sources and cooling mechanisms. Each subsystem may operate in coordination to ensure continuous availability, scalability, and fault tolerance and the ability to scale up and scale out in response to increasing computational and storage demands.

The architecture of a data center 900a may include multiple physical and logical components that collectively enable high-performance computing and data handling. The compute layer may include server racks populated with processors optimized for general-purpose or specialized workloads, including central processing units (CPUs), graphics processing units (GPUs), and field-programmable gate arrays (FPGAs). The storage layer may incorporate hierarchical storage systems that may employ high-speed interfaces such as Non-Volatile Memory Express (NVMe) to reduce latency. The networking layer may use top-of-rack switches, aggregation switches, and core routers arranged in various topologies, (e.g., crossbar, Clos, leaf-spine, etc.) to provide non-blocking connectivity and minimize hop count between endpoints. Power distribution units (PDUs), uninterruptible power supplies (UPS), and backup generators may form the electrical infrastructure, while cooling systems may employ air-based or liquid-based heat dissipation techniques to maintain thermal stability. These components may be integrated to achieve high reliability, modular scalability, and compliance with performance, enabling the system to scale up and scale out as operational loads increase.

In operation, a data center may process client requests through a multi-stage workflow that includes traffic distribution, application execution, and data retrieval. Incoming requests may be received by a load balancing system configured to allocate workloads across multiple compute nodes to prevent resource saturation. Application servers may execute the requested operations, which may involve accessing structured or unstructured data stored within the storage subsystem. Virtualization technologies may enable multiple virtual machines to operate on a single physical server, thereby optimizing resource utilization. Containerization frameworks, such as those implementing Linux containers, may provide isolated execution environments for microservices and facilitate rapid deployment across heterogeneous hardware. The networking subsystem may ensure deterministic packet routing and congestion management through high-speed interconnects and software-defined networking protocols. This operational workflow may be designed to maintain low latency, high throughput, and fault-tolerant performance under variable load conditions, while supporting the ability to scale up and scale out dynamically.

Conventional data center implementations may exhibit several advancements aimed at improving efficiency, scalability, and sustainability. Hyperscale architectures may employ large-scale server clusters interconnected through high-bandwidth fabrics to support cloud computing and artificial intelligence workloads. Edge computing deployments may position micro data centers proximate to end-user devices to reduce network latency and enable real-time processing. Specialized accelerators, including GPUs and tensor processing units (TPUs), may be increasingly integrated to support machine learning and high-performance computing applications. Energy efficiency initiatives may incorporate renewable energy sources and advanced cooling methodologies, such as liquid immersion cooling, to reduce operational costs and environmental impact. These trends reflect an industry-wide transition toward architectures that may be highly distributed, workload-optimized, and environmentally sustainable.

A scale-up network architecture may be characterized by the addition of resources within a single network node or chassis to increase capacity. In such configurations, performance improvements may be achieved by augmenting the processing capability, memory, or port density of an existing switch or router. This approach may involve deploying high-capacity modular switches with vertically integrated backplanes and high-bandwidth switch fabrics. The scale-up model may be advantageous for environments having centralized control and minimal inter-node latency, as all traffic may be processed within a single logical device.

A scale-out network architecture may be characterized by the horizontal expansion of network capacity through the addition of multiple interconnected nodes. In this configuration, performance and scalability may be achieved by distributing workloads across multiple switches, for example arranged as a leaf-spine architecture. Each leaf switch may provide connectivity to compute and storage resources, while spine switches interconnect the leaf layer to form a non-blocking, high-bandwidth fabric. The scale-out model may enable incremental capacity expansion without replacing existing infrastructure, thereby supporting elastic growth and fault tolerance. This architecture may be particularly suited for large-scale data centers and cloud environments, where traffic patterns may be highly distributed and use predictable bandwidth. Scale-out networks may leverage parallelism and redundancy to achieve near-linear scalability.

A scale-up network may carry information, including artificial intelligence (AI) training and inference algorithms, among computing units (such as graphics processing units (GPUs)). These networks may have various characteristics such as high bandwidth (e.g., non-blocking all-to-all bandwidth), low latency (e.g., minimize layers of switching and per-switch latency), and scalability (e.g., supporting high numbers of interconnected GPUs and low energy per bit transferred through network). For purposes of this disclosure, a “GPU” has been provided as an example and instances of GPU may be substituted by any type of processor such as CPUs, ASICs, or the like.

Conventional scale-up networks may centralize the switching/routing function in order to scale GPU connectivity across multiple rack units and even multiple racks. An example compute rack may include 18 compute trays consuming about 6kW each, and 9 switch trays consuming about 1kW each. Each GPU may have 18 ports of 100GB/s each (or 1.8TB/s per GPU), and the rack network (which may be implemented using a copper backplane) may connect each GPU to the 9 switch trays to provide each GPU with the ability to deliver all of its 1.8TB/s to any other GPU in the rack, a capability often referred to as “All-to-All bandwidth”. This may be used for parallelizing the computation of an AI model for training or inference purposes.

This rack-level power density may be quite high and push the limit of electrical power and thermal cooling densities, leaving little room for additional compute trays. Furthermore, switch connectivity for all-to-all crossbar-like functionality has complexity and power which may vary quadratically with the number of ports being interconnected, so scaling the GPUs connected within a rack may be constrained, even when the number of GPUs may be increased.

A centralized full crossbar may be replaced with distributed crossbars which places ultra-efficient, ultra-low-latency analog crossbars locally with their respective GPUs, and routes them to digital switch system on chips (SOCs) with an arrangement of crossbars which may be simplified compared with full crossbars. This may drive improvements in network power, latency, complexity, and scalability.

As a result, network traffic (e.g., which may be AI traffic) may be matched with low predictable latency providing all-to-all bandwidth. Compared to Ethernet packet switches, 1/5 of the power may be consumed. The device may be capable of high radix implementations (e.g., 1024 lanes). The device may be usable in all-copper backplane scale ups as well as with multi-mode (MM) fiber.

Thus, the examples described herein present systems and methods for an Analog Electrical Circuit Switch (AECS) switch capable of ultra-low-latency (e.g., <5ns, 10 ns, or the like) and low-power switching across a flexible any-to-any crossbar architecture. The AECS switch eliminates internal buffering and packet inspection within the crossbar, allowing for a highly efficient and scalable architecture. A programmable crossbar configuration may dynamically map input ports to output ports in response to real-time traffic conditions.

An example system may include advanced control mechanisms for broadcasting and multicasting data from a single input to multiple outputs, optimizing resource allocation and minimizing overhead. Make-before-break (MBB) protocols may be employed to ensure seamless reconfiguration of crossbar connections without data loss, even during high-speed operations. Additionally, adaptive equalization techniques may be integrated into the system, allowing the AECS to optimize signal quality based on feedback from connected devices.

An architecture may include redundancies along with digital signal processors (DSPs) configured to support any-to-any connections. In such an arrangement, low-latency switching along with low power use per lane may be achieved. Further, memory included in the DSPs may be used for any storage or buffering and each of the components included in the switch may include redundant lanes such that degradations or broken DSPs may be rerouted around and replaced without losses to the system. The reconfiguration in the switch may be dynamically performed (e.g., such as in view of real-time traffic managed by the switch) by a switch controller that may communicate with the components in the switch using out-of-band traffic so as to not interfere with the in-band communications otherwise being handled by the switch.

FIG. 9B illustrates an example switch device 900b. The switch device 900bmay include a first digital signal processor (DSP) device 905a, a second DSP device 905b, an nth DSP device 905c, referred to collectively as multiple first electronic devices 905, a first analog integrated circuit (IC) 910a, a second analog IC 910b, an mth analog IC 910c, referred to collectively as multiple second electronic devices 910, a switch controller 915, in-band traffic 920, and out-of-band traffic 925. First DSP 905a, second DSP 905b, and nth DSP 905c may have input and output.

The switch device 900b may be reconfigurable (e.g., in terms of the connections between the components therein, such as the multiple first electronic devices 905 and the multiple second electronic devices 910, the switch controller 915, and/or a device 930b), where the switching of the connections/lanes between the components may be low latency (e.g., less than 5 ns, 10ns, or the like switching). Alternatively, or additionally, the switch device 900b may reconfigure without the use of retiming such that each lane of the multiple lanes included therein may use less than 50 mW of power. For example, each lane of the multiple lanes may support 100G bandwidth while using less than 50 mW of power.

The multiple first electronic devices 905 may individually include one or more ports that may be used to facilitate communications within the switch device 900b, such as between the multiple first electronic devices 905 and the multiple second electronic devices 910, the switch controller 915, and/or a device 930b. The communications in the switch device 900bmay be transmitted via multiple lanes in the switch device 900b. The multiple lanes may facilitate the in-band traffic 920 and/or the out-of-band traffic 925.

The multiple lanes between the multiple first electronic devices 905 and the multiple second electronic devices 910 may be in an any-to-any configuration. For example, the first DSP device 905a may include a lane to the first analog IC 910a, to the second analog IC 910b, and/or the mth analog IC 910c. A similar arrangement may occur for each of the multiple first electronic devices 905, such that each DSP device of the multiple first electronic devices 905 may include a lane to any number of the multiple second electronic devices 910, including none of the multiple second electronic devices 910. Each lane for facilitating the in-band traffic 920 may be in both directions (e.g., transmit and receive) between the multiple first electronic devices 905, the multiple second electronic devices 910, and/or a device 930b. Alternatively, or additionally, the lanes are dashed/dotted to illustrate that for any transmit/receive path between the multiple first electronic devices 905, the multiple second electronic devices 910, and/or a device 930b, a lane may or may not be present.

The multiple first electronic devices 905, the multiple second electronic devices 910, and/or the switch controller 915 may be disposed on a printed circuit board (PCB) where traces on the PCB may be used to connect at least the multiple first electronic devices 905, the multiple second electronic devices 910, and/or the switch controller 915 (e.g., the traces on the PCB may facilitate the in-band traffic 920 and/or the out-of-band traffic 925 in the switch device 900b). Alternatively, or additionally, the multiple first electronic devices 905, the multiple second electronic devices 910, and/or the switch controller 915 may be connected to one another using connectors, such as high-speed cables, where the multiple first electronic devices 905, the multiple second electronic devices 910, and/or the switch controller 915 may individually include ports/headers to support the use of the connectors. In instances in which the connectors are used, crosstalk between the multiple lanes in the switch device 900b may be reduced relative to the crosstalk that may occur when the switch device 900buses traces on a PCB.

The switch device 900b, including the multiple first electronic devices 905, the multiple second electronic devices 910, and/or the switch controller 915, may be utilized with one or more additional switches and/or crossbar devices to form a new crossbar switch device, which may be larger than any one of the switch devices 900b. For example, as illustrated and discussed relative to FIG. 9C, the switch device 900b may be utilized with any other number of switch devices 900b (e.g., the nth switch device 900ac in FIG. 9D) and multiple analog crossbar switches 940 to form a new crossbar switch device.

The multiple first electronic devices 905 may be digital signal processors (DSPs) and/or the multiple second electronic devices 910 may be analog circuit switch integrated circuits (ICs) for use with electrical signals. Alternatively, or additionally the multiple second electronic devices 910 may be analog optical circuit switch ICs for use with optical signals. The multiple first electronic devices 905 may be individually configured to support one or more layer of the open systems interconnection (OSI) model. For example, each of the multiple first electronic devices 905 may be configured to support layer 1 protocols, layer 2 protocols, and/or layer 3 protocols with respect to the in-band traffic 920 and/or the out-of-band traffic 925.

Each, or at least one, of the multiple first electronic devices 905 may support layer 1 protocols, which may include detecting and/or processing layer 2 protocols and/or layer 3 protocols, handling layer 2 protocol and/or layer 3 protocol addressability, frame header detection, packet header inspection, responding to layer 2 protocol and/or layer 3 protocol requests, storing information in response to a request associated with layer 2 protocols and/or layer 3 protocols, updating information in response to a request associated with layer 2 protocols and/or layer 3 protocols, communicating information in response to a request associated with layer 2 protocols and/or layer 3 protocols, optimizing information in response to a request associated with layer 2 protocols and/or layer 3 protocols, etc. Each of the multiple first electronic devices 905 may be able to adjust the way in which traffic is directed through it, such as in response to a command from the switch controller 915. For example, each of the multiple first electronic devices 905 may be operable to configure an internal switch, an external switch, or a crossbar based on the various layer protocol processing to be performed.

The first DSP device 905a may receive a communication that includes a frame header (or a packet header) and the first DSP device 905a may be configured to detect the frame header and decode the frame header along with any associated contents of the communication, all within the first DSP device 905a. In a second example, the first DSP device 905a may integrate a media access control (MAC) address lookup table which may allow the first DSP device 905ato configure one or more crossbars such that the first DSP device 905a may facilitate connectivity between any two MAC addresses that are included in the lookup table. Alternatively, or additionally, each of the first electronic devices 905 may include a lookup table that may store equalization settings that may be used for various connections between the first electronic devices 905 and other components within the switch device 900b. The equalization settings in the lookup table may be used to accelerate acquisition and/or tracking for a particular DSP device of the multiple first electronic devices 905 when the particular DSP device switches connections within the switch device 900b.

The multiple first electronic devices 905 may be configured to respond to layer 2 protocol requests and/or layer 3 protocol requests for connectivity and/or resource grant requests. For example, the multiple first electronic devices 905 may compare a request to a lookup table that includes priority levels and the multiple first electronic devices 905 may be operable to configure themselves and/or associated crossbars and/or switches based on the determined priority level. Alternatively, or additionally, each of the multiple first electronic devices 905 may be configured to respond to in-band requests (e.g., granting a connection request, signaling backpressure to the device 930b, etc.), collect statistics on traffic handled by the multiple first electronic devices 905 (e.g., link utilization and/or traffic type), and/or perform data filtering (e.g., detecting a particular header, performing routing, generating flags and/or interrupts, and/or logging any of the filtering events).

The multiple first electronic devices 905 may be configured to communicate with (e.g., transmit data to and/or receive data from) the device 930b. The communication with the device 930bmay include in-band traffic 920. In such instances, the communications between the multiple first electronic devices 905 and the device 930b may be line-side communications, where the lines may facilitate communications using various communication channels. For example, the line-side communications between the multiple first electronic devices 905 and the device 930b may be an electrical-to-electrical connection, an optical-to-optical connection, an electrical-to-optical connection, or an optical-to-electrical connection, and so forth.

The device 930b may address communications directly to one of the multiple first electronic devices 905. For example, the device 930bmay address communications to the second DSP device 905b. Alternatively, or additionally, the device 930bmay address communications to the switch controller 915, which may then direct communications to the appropriate DSP device. For example, the device 930bmay address communications intended for the second DSP device 905b to the switch controller 915 and the switch controller 915 may direct the communications to the second DSP device 905b.

The multiple first electronic devices 905 may individually include memory that may be used as a buffer for communications through the multiple first electronic devices 905. The memory in the multiple first electronic devices 905 may be utilized to buffer incoming and/or outgoing traffic, which may include in-band traffic 920 and/or out-of-band traffic 925. Due to the memory in the multiple first electronic devices 905 being distributed (e.g., by the distributed nature of the multiple first electronic devices 905), the switch device 900b may not include any memory for buffering in addition to the memory included in the multiple first electronic devices 905.

The multiple first electronic devices 905 may individually include one or more additional lanes that may be used for communications in the switch device 900b. Further details associated with the additional lanes are included in the description associated with FIG. 9C.

The multiple second electronic devices 910 may individually include one or more ports that may be used to facilitate communications within the switch device 900b, similar to the ports described relative to the multiple first electronic devices 905. Alternatively, or additionally, the lanes for communications between the multiple first electronic devices 905 and the multiple second electronic devices 910 may be coupled with the ports included in the multiple second electronic devices 910.

The switch controller 915 may be a microcontroller unit (MCU). Alternatively, or additionally, the switch controller 915 may be a DSP, or other processing device. The switch controller 915 may be communicatively coupled with at least the multiple first electronic devices 905 and/or the multiple second electronic devices 910. The switch controller 915 may resolve resource grant requests, distribute the network state to the multiple first electronic devices 905 and/or to the multiple second electronic device 910, and/or may establish and/or maintain timing among the components included in the switch device 900b.

The switch controller 915 may communicate with the multiple first electronic devices 905 and/or the multiple second electronic devices 910 using a separate connection/lane than the connections between the multiple first electronic devices 905 and the multiple second electronic devices 910. For example, the first connection between the multiple first electronic devices 905 and the multiple second electronic devices 910 may facilitate the in-band traffic 920 and the second connection between the switch controller 915 and the multiple first electronic devices 905 and/or the multiple second electronic devices 910 may facilitate the out-of-band traffic 925.

The out-of-band traffic 925 may use a different network than the in-band traffic 920. Alternatively, or additionally, the out-of-band traffic 925 may use a different physical layer protocol than the in-band traffic 920. The out-of-band traffic 925 may be used to manage and/or configure one or more components included in the switch device 900b. For example, the switch controller 915 may communicate with the multiple first electronic devices 905 using the out-of-band traffic 925 to reconfigure lanes and/or traffic routing based on the traffic through the switch device 900b.

The switch controller 915 may be programmable such that the switch controller 915 may be operable to dynamically map the lanes between the multiple first electronic devices 905 and the multiple second electronic devices 910. For example, in instances in which the first DSP device 905a includes a lane to the first analog IC 910a, the switch controller 915 may dynamically map the lane to be from the first DSP device 905a to the second analog IC 910b. The switch controller 915 may dynamically adapt the mapping of the lanes between the multiple first electronic devices 905 and the multiple second electronic devices 910 based on one or more conditions and/or a satisfaction of a threshold related to the conditions. For example, in instances in which the real-time data traffic in the switch device 900b (or an amount of real-time data traffic handled by one of the multiple first electronic devices 905 and/or one of the multiple second electronic devices 910) satisfies a threshold, the switch controller 915 may dynamically adapt the mapping of the lanes as described.

The switch device 900b may include one or more redundant lanes that may be used in various situations during operation of the switch device 900b. For example, one or more redundant lanes may be used for the out-of-band traffic 925, such as signaling using the out-of-band traffic 925. In such instances, the out-of-band signaling may be transmitted and/or received by a particular DSP device and/or by the switch controller 915, and the out-of-band signaling may be a lower transmission rate than the in-band traffic 920. In another example, one or more redundant lanes may be used for out-of-bandwidth broadcasts from the switch controller 915 and/or from one or more of the multiple first electronic devices 905 to other devices in the switch device 900b (e.g., such as other DSP devices).

The switch controller 915 may reserve a portion of bandwidth associated with the in-band traffic 920 in the switch device 900b. The bandwidth reserved by the switch controller 915 may be reserved on a per lane basis of the multiple lanes included in the switch device 900b. For example, a first lane between the first DSP device 905a and the first analog IC 910a may have a first reserved bandwidth and a second lane between the second DSP device 905b and the second analog IC 910b may have a second reserved bandwidth, where the amount of bandwidth reserved may be the same or may differ between the first reserved bandwidth and the second reserved bandwidth. The switch controller 915 may allocate resources within the switch device 900bbased on predicted or anticipated traffic (e.g., based on a probabilistic model).

Alternatively, or additionally, the switch controller 915 may monitor the lanes of the multiple lanes in the switch device 900b. The switch controller 915 may monitor the multiple lanes periodically and/or in a round robin manner, such that the lanes of the multiple lanes may observed to determine if failures or degradations may be present in a lane. In instances in which a lane experiences a degradation that satisfies a threshold for an acceptable loss, the switch controller 915 may dynamically remap a new lane in the switch device 900b to replace the degraded lane.

The switch controller 915 may perform adaptive signal equalization to the in-band traffic 920 in the switch device 900b. For example, the multiple first electronic devices 905 may provide feedback to the switch controller 915 relative to the workload handled by the multiple first electronic devices 905, and the switch controller 915 may adaptively manage workloads of the multiple first electronic devices 905 to optimize performance of the switch device 900b.

A backup switch controller (not illustrated) may be included in the switch device 900b. The backup switch controller may be a redundant controller relative to the switch controller 915. The backup switch controller may include the same or similar connections as the switch controller 915 relative to the multiple first electronic devices 905 and/or the multiple second electronic devices 910. The backup switch controller may perform the same or similar operations as the switch controller 915.

FIG. 9C illustrates an example switch device 900c. The switch device 900c may include a first DSP device 905a, an nth DSP device 905c, and multiple analog ICs 935. The first DSP device 905amay include a first auxiliary channel 907a, and a first out-of-band channel 909a. The nth DSP device 905cmay include an nth auxiliary channel 907c, and an nth out-of-band channel 909c.

The first DSP device 905a, the nth DSP device 905c, and the multiple analog ICs 935 may be the same or similar as the first DSP device 905a, the nth DSP device 905c, and the multiple second electronic devices 910, respectively, of FIG. 9B and may be operable to perform the same or similar functions as described.

The auxiliary channels 907 (e.g., the first auxiliary channel 907aand the second auxiliary channel 907c) may be individually utilized by each of the DSP devices 905a, 905c as an additional lane for in-band traffic between at least the DSP devices 905a, 905c and the multiple analog ICs 935. The auxiliary channels 907 may be used to redundantly transmit in-band traffic relative to another lane included in the DSP devices 905a, 905c prior to a change in configuration to the corresponding DSP devices 905a, 905c. For example, in instances in which the first DSP device 905a includes a lane to a particular analog IC of the multiple analog ICs 935 and the first DSP device 905a is to be reconfigured (e.g., by a switch controller as described herein), the first auxiliary channel 907a may have a lane mapped to the particular analog IC such that the in-band traffic is redundant between the first DSP device 905a and the particular analog IC prior to reconfiguring the lanes associated with the first DSP device 905a (which reconfiguration may otherwise break the connection between the first DSP device 905a and the particular analog IC).

The auxiliary channels 907 may be used for communication between other near DSP devices. For example, in instances in which the first DSP device 905a is disposed spatially near to the nth DSP device 905c, the first DSP device 905a and the nth DSP device 905c may communicate with one another via the auxiliary channels 907. Such communications may be possible as the channels between near-neighbors may be relatively clean, such that physical layer processing may be simplified and may result in power reduction, latency reduction, a lesser amount of equalization, and/or other benefits to the switch device 900c.

The out-of-band channels 909 may be used to communicate the out-of-band traffic (e.g., the out-of-band traffic 925 of FIG. 9B) on a lane separate from the multiple lanes used to communicate in-band traffic. In such instances, the out-of-band channels 909 may not cause blocking or interference to the in-band traffic between at least the DSP devices 905a, 905c and the multiple analog ICs 935.

FIG. 9D illustrates an example aggregated switch device 900d. The aggregated switch device 900dmay include a first switch device 900aa, an nth switch device 900ac, and multiple analog crossbar switches 940. The first switch device 900aa and the nth switch device 900ac may individually be the same or similar as the switch device 900b of FIG. 9B.

The aggregated switch device 900d illustrates that any number of the switch devices 900b (e.g., the first switch device 900aa and the nth switch device 900ac) may be aggregated into another switch device and/or connected to other analog crossbar switches. Each of the switch devices 900bmay include multiple DSP devices and multiple analog IC and may be further aggregated into the aggregated switch device 900d using the multiple analog crossbar switches 940. As such, the aggregated switch device 900d may be scaled up or down for any size communication need, by adjusting the switch devices 900band/or the multiple analog crossbar switches 940 to meet the communication demand.

### Examples

Example 1 may include selecting the first selected path based on one or more of an input channel estimate or an output channel estimate.

Example 2 may include selecting the first selected path during a runtime.

Example 3 may include the first linear path is an un-retimed path.

Example 4 may include the first retimed path further includes one or more of a continuous time linear equalizer (CTLE), an ADC, a receive path DSP, an analog input with path select, a transmit path DSP, a digital-to-analog converter (DAC), or a pre-equalizer.

Example 5 may include receiving the signal from a first crossbar coupled to a first side of the DSP.

Example 6 may include overriding, at a management layer, the first selected path.

Example 7 may include assessing un-retimed margin based on one or more channel characteristics.

Example 8 may include monitoring a quality of a received signal.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A digital signal processor (DSP), comprising:
a first path comprising a first path-select operable to select a first linear path or a first retimed path; and
a second path comprising a second path-select operable to select a second linear path or a second retimed path.

2. The DSP of claim 1, wherein:
the first path-select is operable to select the first linear path or the first retimed path based on one or more of an input channel estimate or an output channel estimate; or
the second path-select is operable to select the second linear path or the second retimed path based on one or more of the input channel estimate or the output channel estimate.

3. The DSP of claim 1, wherein:
the first path-select is operable to select the first linear path or the first retimed path during a runtime; or
the second path-select is operable to select the second linear path or the second retimed path during the runtime.

4. The DSP of claim 1, wherein:
the first retimed path further comprises one or more of a continuous time linear equalizer (CTLE), an analog-to-digital converter (ADC), a receive path DSP, an analog input with path select, a transmit path DSP, a digital-to-analog converter (DAC), or a pre-equalizer; or
the second retimed path further comprises one or more of a CTLE, an ADC, a receive path DSP, an analog input with path select, a transmit path DSP, a digital-to-analog converter (DAC), or a pre-equalizer.

5. The DSP of claim 1, wherein one or more of the first linear path or the second linear path is an un-retimed path.

6. The DSP of claim 1, further comprising:
a first crossbar coupled to a first side of the DSP; and
a second crossbar coupled to a second side of the DSP.

7. The DSP of claim 1, further comprising:
a management layer operable to override one or more of the first path-select or the second path-select.

8. The DSP of claim 1, wherein the DSP is further operable to assess un-retimed margin based on one or more channel characteristics.

9. The DSP of claim 1, wherein the DSP is further operable to monitor a quality of a received signal.

10. A system, comprising:
a digital signal processor (DSP) comprising:
a first path comprising a first path-select operable to select a first linear path or a first retimed path; and
a second path comprising a second path-select operable to select a second linear path or a second retimed path; and
a first crossbar coupled to a first side of the DSP; and
a second crossbar coupled to a second side of the DSP.

11. The system of claim 10, wherein:
the first path-select is operable to select the first linear path or the first retimed path based on one or more of an input channel estimate or an output channel estimate; or
the second path-select is operable to select the second linear path or the second retimed path based on one or more of the input channel estimate or the output channel estimate.

12. The system of claim 10, wherein:
the first path-select is operable to select the first linear path or the first retimed path during a runtime; or
the second path-select is operable to select the second linear path or the second retimed path during the runtime.

13. The system of claim 10, wherein:
the first retimed path further comprises one or more of a continuous time linear equalizer (CTLE), an analog-to-digital converter (ADC), a receive path DSP, an analog input with path select, a transmit path DSP, a digital-to-analog converter (DAC), or a pre-equalizer; or
the second retimed path further comprises one or more of a CTLE, an ADC, a receive path DSP, an analog input with path select, a transmit path DSP, a digital-to-analog converter (DAC), or a pre-equalizer.

14. The system of claim 10, wherein one or more of the first linear path or the second linear path is an un-retimed path.

15. The system of claim 10, wherein:
the first crossbar is a 2x1 crossbar; or
the second crossbar is a 2x1 crossbar.

16. The system of claim 10, further comprising a management layer operable to override one or more of the first path-select or the second path-select.

17. The system of claim 10, wherein the DSP is further operable to assess un-retimed margin based on one or more channel characteristics.

18. The system of claim 10, wherein the DSP is further operable to monitor a quality of a received signal.

19. A method, comprising:
receiving, at a digital signal processor (DSP), a signal on a first path;
selecting, at the DSP, a first linear path or a first retimed path to determine a first selected path; and
sending, at the DSP, the signal to the first selected path.

20. The method of claim 19, further comprising:
receiving, at a digital signal processor (DSP), a signal on a second path;
selecting, at the DSP, a second linear path or a second retimed path to determine a second selected path; and
sending, at the DSP, the signal to the second selected path.
